(19) United States
(12) Patent Application Publication
(10) Pub. No.: US 2022/0414694 A1
(43) Pub. Date: Dec. 29, 2022

(54) CONTEXT AWARE CHAT CATEGORIZATION FOR BUSINESS DECISIONS

(71) Applicant: ROAR IO Inc. DBA Performlive, East Hanover, NJ (US)

(72) Inventors: Oksana Sokolovsky, East Hanover, NJ (US); Rohit Mahajan, Redmond, WA (US); Ram Dayal Goyal, Bangalore (IN); Subhodeep Dey, Kolkata (IN)

(73) Assignee: ROAR IO Inc. DBA Performlive, East Hanover, NJ (US)

(21) Appl. No.: 17/359,798

(22) Filed: Jun. 28, 2021

(51) Int. Cl. G06Q 30/02; G06Q 50/00; G06Q 10/10; G06N 3/04; G06N 3/08; H04L 12/58; G06F 40/284

(52) U.S. Cl. CPC G06Q 30/0204; G06Q 50/01; G06Q 30/0201; G06Q 10/10; G06N 3/0445; G06N 3/0454; G06N 3/08; H04L 51/22; G06F 40/284

(57) ABSTRACT

Described herein is a method of context aware chat categorization for business decisions. A business category of the chat presented by the viewer/user on a platform is predicted and groups of chats having similar context and created and arranged in an ordered score indicative of importance. The categorization method includes applying LSTM's in parallel with shared embeddings on said user data, applying an LSTM technique to determine sentence similarity, applying the user's social connectivity in the form of Eigen-centrality of its connectivity on said platform, determining the customised loss function, grouping of chats in categories based on context, context based grouping of chats wherein context is obtained from chat description, and determining attention score based on textual representation of human emotions such as emojis, repetitive characters, and words for each group of chats in a category.

### BACKGROUND OF THE INVENTION

This invention in general relates to online communication, and specifically to chat categorization.

There is an unmet need to efficiently categorize and cluster online chat communication in order to take effective business decisions for customer service.

### BRIEF DESCRIPTION OF FIGURES

FIG. 1 illustrates an example method of chat categorization, in accordance with some implementations.

FIG. 2 illustrates example grouping of chats and computing the attention score of each group, in accordance with some implementations.

FIG. 3 illustrates an example architecture of the LSTM module for determining sentence similarity, in accordance with some implementations.

FIG. 4 illustrates example LSTM modules used for chat classification, in accordance with some implementations.

FIG. 5 illustrates similarity within chats, in accordance with some implementations.

FIG. 6A depicts an adjacency matrix, in accordance with some implementations.

FIG. 6B illustrates Eigen value calculation based on the user's historical information, in accordance with some implementations.

FIG. 7 exemplarily illustrates the categories of chats, in accordance with some implementations.

FIG. 8 illustrates an example method of clustering of chats, in accordance with some implementations.

FIG. 9 illustrates results of clustering, in accordance with some implementations.

FIG. 10 illustrates an example method of segmentation of chats into positive and negative sentiments, in accordance with some implementations.

FIG. 11 exemplarily illustrates the results of segmentation of chats into positive and negative sentiments, in accordance with some implementations.

FIG. 12 illustrates an example method of computing the attention scores, in accordance with some implementations.

FIG. 13 illustrates example results of computed attention scores, in accordance with some implementations.

FIG. 14 illustrates a dendrogram on the clustering of chats, in accordance with some implementations.

### SUMMARY OF THE INVENTION

Disclosed herein is a System for Categorization and Clustering (SCC) for chat communication, hereafter referred to as a “SCC platform” or simply “platform” wherein a creator may live stream via mobile or web app, and viewers, fans, and/or audience, etc. may engage with the creator in a dialog via a chat interface.

It is an aspect of the invention to predict the business category of the chat presented by the viewer/audience/fan on the Platform via Live; and create groups of the chats which have similar context and arrange those groups in ordered score indicating the importance.

It is an aspect of the invention to present an integrated solution to predict the business category by combining information from the live chat and the text generated from the Creator's audio content, weighted by the importance of the user's social connectivity.

It is an aspect of the invention to arrange the chat group by similar contexts and compute the attention score for each group for each business category.

Amongst the chat interactions, there will be chats having different focus e.g., a few chats will be ‘Greeting’ focused and are thereby not very ‘business’ relevant. There will be chats in which the viewer/user will be curious about the product, curious about the schedules, pricing, etc. and hence quite valuable for the event organizers. Hence the SCC platform will be designed to categorize the chats in appropriate user defined business categories.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer implemented method of chat categorization of user(s) on an online platform. The computer implemented method of chat categorization of user also includes passing chat text of said user(s) and chat text of said one or more performers into a first pretrained similarity LSTM model to generate an output score which measures the similarity of the chat text of said user(s) and the chat text of the one of more performers, where said output score is a sigmoid score; passing the chat text of said user(s) and the chat text of the one or more performers through a second pretrained classification LSTM model in parallel, and generating two corresponding two output vectors; multiplying said sigmoid score with said output vectors to create a consolidated vector; passing said consolidated vector into a dense layer of a neural network and classifying chats in said chat session into a set of categories; and determining a customised loss function. Other embodiments of this aspect include corresponding computer systems, apparatus, and computer programs recorded on one or more computer storage devices, each configured to perform the actions of the methods.

Implementations may include one or more of the following features. The method where, said first pretrained similarity LSTM model encodes information of the user(s), and second pretrained classification LSTM model encodes information of a matching performer's content. The method may include, prior to passing the chat texts through a corresponding LSTM module, tokenizing the chats and generating a sequence on the chats to convert the chat into numeric representations. The method may include determining a social connectivity of the user(s) based on an eigen centrality of a user graph that is generated from an adjacency matrix of the user(s) on an online social media platform. Said customized loss function is a harmonic mean of an eigen centrality of the user obtained by an adjacency matrix and a standardised value of a number of sessions attended by the user or a number of products purchased by the user. Said customized loss function uses past behaviour and social connectivity of the said user(s) for a prediction of a chat category by modifying the loss function. Implementations of the described techniques may include hardware, a method or process, or computer software on a computer-accessible medium.

One general aspect includes a computer implemented method of context based clustering of chat sessions of a set of users on an online platform. The computer implemented method of context based clustering also includes clustering said chats and grouping the chats based on similarity of context of each chat; extracting context from each chat session, grouping of the chat sessions into categories based on the respective context, computing an emotional weight for the each chat session, and determining an attention score for each group of chat sessions in a category. Other embodiments of this aspect include corresponding computer systems, apparatus, and computer programs recorded on one or more computer storage devices, each configured to perform the actions of the methods.

Implementations may include one or more of the following features. The method may include concatenating the user and the performer output with a user history vector. Said user history vector is generated using a user data base of historical purchases and a user-user adjacency matrix. Said user history vector may include information about the user in terms of a number of sessions attended by the user, a number of products purchased by the user, and a mode of the business category selected by the user. Each said clustered chat session is divided into two sub groups based on positive and negative sentiment of the chat sessions. Said clustering may include: determining features from each chat and assigning suitable weights, where each chat is treated as an individual cluster; determining an inter-cluster distance for all clusters, where a suitable distance is applied with use of different weights for different features; identifying two clusters having a minimum distance and grouping them together; and updating the inter-cluster distance and iterating until a single cluster or a desired number of clusters is determined. For each subgroup of chat sessions, an attention score is computed using textual content representing emotion such as emojis and a number of chats. A final report is presented to an event organizer to take a desired business action. The said step of determining the attention score may include the step of: computing the emotional weight (EW) EW=sqrt[(RepE)\hat{ }2+(RepW)\hat{ }2+(RepL)\hat{ }2]; computing an attention weight (AW) for a chat AW=EW*|S|, where EW is emotional weight and |S| is magnitude of sentimental score of chat; and computing the attention score for a group of chats, where for a group of chats having n chats per review, the attention weight of each chat and the attention score is computed using the relation,

$$AS = {\sum }_{i = 1}^{i = n} {AW}_{i} .$$

if said chat is in audio format, said audio format is converted to text using a speech recognition module. Implementations of the described techniques may include hardware, a method or process, or computer software on a computer-accessible medium.

One general aspect includes an online chat categorization and clustering system applied to a set of users and performers communicating on an online platform in chat sessions. The online chat categorization also includes at least one processor; a non-transitory computer readable storage medium communicatively coupled to said at least one processor, said non-transitory computer readable storage medium configured to store modules of said online chat categorization and clustering system, said at least one processor configured to execute said modules of said online chat categorization and clustering system; and said modules of said online chat categorization and clustering system may include: a categorization module for chats may include: a first LSTM module for receiving said user's text and the performer's text, and applying a pretrained similarity LSTM model to generate an output score that measures a similarity of said user's text and said performers text, where said output score is a sigmoid score; a second LSTM module for receiving said user's text and the performer's text through the two pretrained classification LSTMs in parallel, and generating corresponding two output vectors; a computation module for: multiplying said sigmoid score with said output vectors to create a consolidated vector; and passing said consolidated vector into a dense layer of a neural network and to classify the chats into a set of categories; a clustering module for: determining the customised loss function; extracting context from each chat; grouping of said chats into categories based on context; computing emotional weight for each chat; and determining the attention score for each group of chats in a category. The categorization also includes a reporting module for presenting said categorized, clustered, and attention scores of the chat communication. Other embodiments of this aspect include corresponding computer systems, apparatus, and computer programs recorded on one or more computer storage devices, each configured to perform the actions of the methods.

Implementations may include one or more of the following features. The system wherein said system is a cloud-based system with a collection of servers. Implementations of the described techniques may include hardware, a method or process, or computer software on a computer-accessible medium.

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structures and devices are shown in block diagram form only in order to avoid obscuring the invention.

Moreover, although the following description contains many specifics for the purposes of illustration, anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

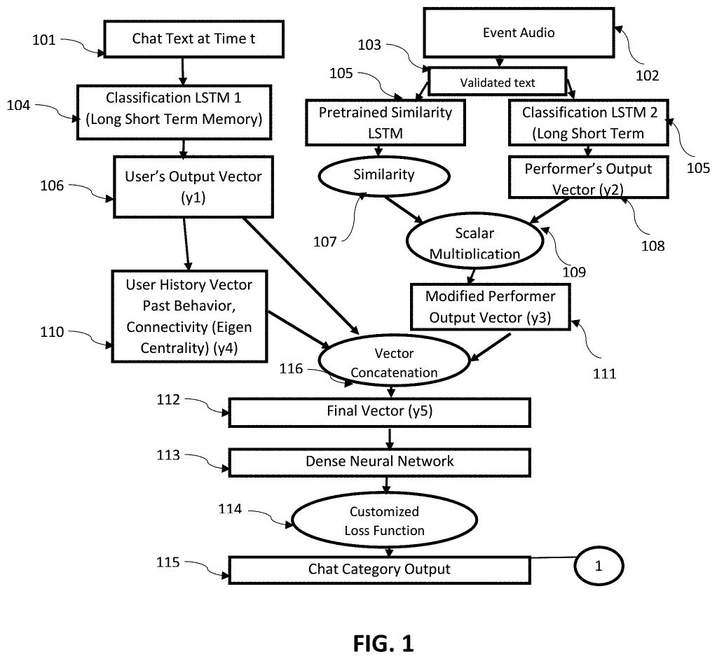

FIG. 1 illustrates an example method of chat categorization. The chat description in natural language is considered for input 101, for example, English language chat inputs. A user's (viewer's) history profile on the platform 110 is considered. The intention behind using the user's history profile is that a solution needs to be designed in such a manner that it can pay extra attention to the chats from a person who has been active on an online event platform and has been buying products earlier.

The user's social connectivity is applied to make the category prediction. The motive behind using social behaviour is to estimate how well the user is connected ‘socially’ and the user's level of importance as a customer. Extract the graph of a user from online social media platform and feed that information by using the Eigen centrality 110 and include the value to modify the custom loss function.

Audio content extracted in the form of text 102 within the time proximity of the chat timestamp is also used as an additional information for further improved categorization accuracy.

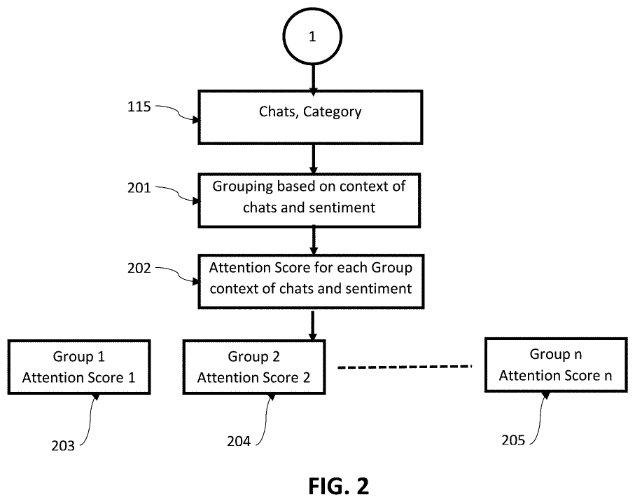

FIG. 2 illustrates the grouping of chats and computing the attention score of each group 203, 204, 205. Once the chats have been categorized 115, the category information is sent to a clustering module which performs the following tasks for each category of chats. Various contexts about the event are extracted from chat description. Thus, the chats in each group 201 will represent one or more contexts. Next, each group is divided into two subgroups based on positive and negative sentiment. Compute an attention score 202 for each subgroup which is based on number of chats in the subgroup and sentiment score of each chat and emotional weight of each chat which is computed using emojis and other textual representation of emotions. Present a report in a dashboard to the event organizer to have a view of the overall feedback of the sessions, follow up with the users who are interested in the product, price, and schedule and address any specific concerns.

The method and system described herein predicts the business category by combining information from the chat and the text generated from the performer's audio content, weighted by the importance of the user's social connectivity, and arranging the chats group by similar contexts having an attention score.

The SCC platform captures the user text, and the performer text is captured 101 by taking a configurable time window, e.g., t−30 seconds, t−10 second, t−5 seconds, t−60 seconds, etc., from the time (t) when the user had started typing. The audio is converted to text and validated 102, 103, using a Speech recognition program module. The user text and the performer text are passed into a pre-trained Similarity LSTM model 105 to generate the output score which measures the similarity of these two chats, the output of which is a sigmoid score. The user text and the performer text are passed through the two pre-trained Classification LSTMs in parallel and the corresponding two output vectors 108 are generated (Performer and the user output vector). The performer output vector is multiplied 111 by the sigmoid score generated from the Similarity 107 LSTM. The user history vector 110 is generated using the user data base of historical purchases, and the user-user adjacency matrix. The user and the performer output vector is concatenated 116 with the user history vector 101. The concatenated vectors 112 are then passed into a dense layer 113 of a neural network. A customized loss function 114 is applied which uses chat user's past behaviour and social connectivity for better prediction of the chat category by modifying the loss function. Chat and predicted category output 115 is sent to a clustering module. All the chats in each category are grouped based on similarity of contexts of each chat. Each cluster is divided into two sub groups based on positive and negative sentiment of the chats. For each subgroup, a score called attention score is computed using textual content representing emotions such as emojis and number of chats. A final report is presented to the event organizer for their desired business action.

The two major components of the method and system described herein comprises classification of chats, the clustering of chats, and computing the attention score of each group.

The classification of chats is described in detail herein. The business category is predicted by a method and system architecture which incorporates four vital forms of information; audio text, chat text, social media connectivity, and a user history of buying products. The chat typed by the users on the online event platform is used as an input. This chat is pre-processed and fed into an embedding layer of a plurality of dimensions, e.g., 10 dimensions, 50 dimensions, etc., which is incorporated in a Classification LSTM module 1 to generate the output y1, which is referred to herein as the user's output vector.

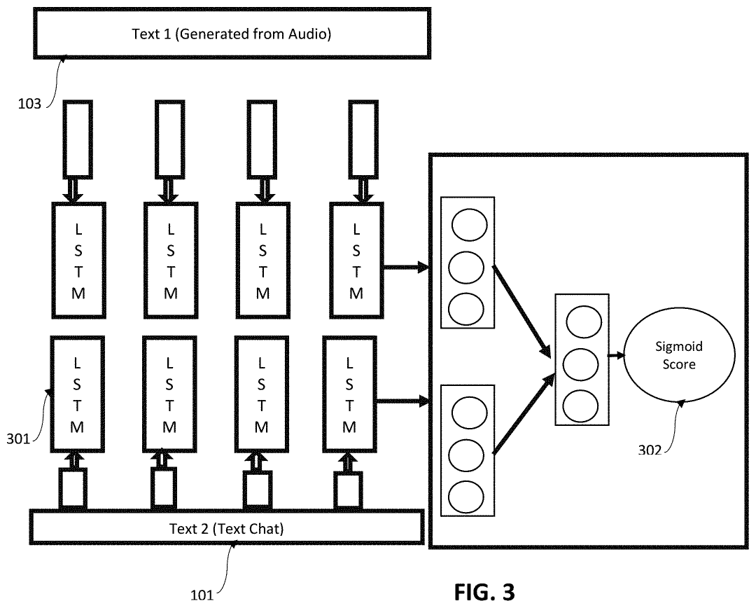

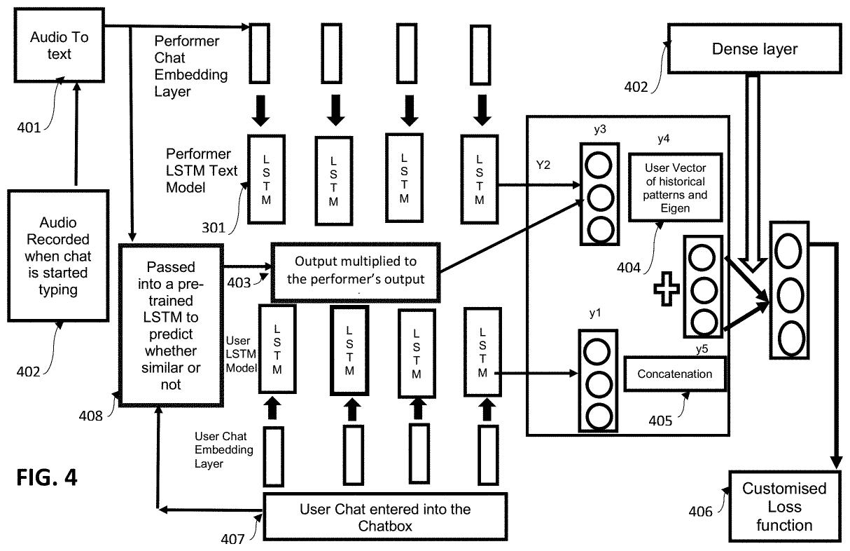

FIG. 3 illustrates example architecture of the LSTM module for determining sentence similarity.

The audio of every session may be recorded continuously. Hence, as soon as the user types the chat, the input is sensed and the audio of the session is recorded for a configurable window, e.g., for the last 30 seconds 402 (configurable window), last 60 seconds, etc. The recorded audio is converted to text 401 using a Speech Recognition module, and a checker is placed to study the sanity of the conversion. If the text is not valid, then chat text itself is utilized. The validated text thereby is pre-processed and fed to the Classification LSTM module 2 via a plurality of dimensions, embedding to generate y2, which from hereon we will refer as the performer's output vector.

Alternatively, the chat and the performer text could be very different, in this case diminish the performer output in terms of predicting the final outcome as the user chat is more relevant. The texts (user and the performer) from the user chat entered into the chat box 407 are passed through a pre-trained Similarity LSTM architecture 408 which has been trained on a data set detecting whether two sentences are similar or not.

The sigmoid output is sent to the Classification LSTM 301 performer output and the vector is multiplied 403 by the sigmoid score to obtain y3. This essentially lets the model know that in cases where the performer and the user's chat are not similar, the dissimilarity could be because of noise in the performer's audio, the performer is playing music instead of talking, the audio to text has certain inaccuracies, or the user may have joined late and is greeting whereas the performer is in the middle of the session.

The y1 and y3 generated is concatenated 405 with the user vector (y4) obtained by storing the user's historical information of the interaction with the platform and the Eigen centrality 404 of the user-user matrix generated using the social media connectivity information.

The final vector (y5) is fed into a dense network 402, and a softmax activation is performed, the output of which is the class of the business intent; and the customized loss function 406 is determined.

The categorical cross entropy function is weighed using the harmonic mean of the Eigen centrality of the user u obtained by the user-user adjacency matrix and the standardised value of number of sessions the user has attended, and the number of products purchased by the user.

Described herein is an example training method for Similarity LSTM. Exemplarily, dummy data of 1500 chats are created, along with the supervision of the type of chat, the classes used were ‘Greetings’, ‘Price’, ‘Product’, ‘Issues’, ‘Future Buying Intent’.

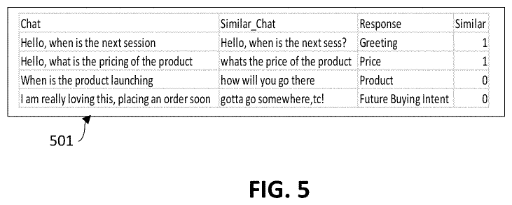

FIG. 5 exemplarily illustrates the similarity within chats.

For example, along with the above 1500 chats, 1500 similar chats are generated (created) in which 750 of the chats are very similar to the corresponding chat on which it is based on and the other 750 of the chats are completely different.

Clean up the text to remove the stop-words and the punctuations, and expand contractions if any. Define a vocabulary size, e.g., 1000, embedding dimensions, e.g., dimensions of 50, max_len (the total number of tokens in a sentence), e.g., 25, assuming that chats will be smaller than 25 tokens. In some other implementations, larger sizes may be utilized. Tokenize the chats and create sequence on the chats to convert the chat into numeric representations. Pre-pad the chats with zeroes in case the length is smaller than 25 tokens. Apply the above-mentioned methodology to both the chat and the similar_chat.

Pass both the sequences to an embedding layer of 50 dimensions to two 20 Neuron LSTMs and concatenate the output to feed into a Dense layer of 100 Neurons, thereafter to a dense layer of 30 Neurons and finally a dense layer of 1 neuron with an activation of sigmoid.

Use a binary cross entropy loss. Training is performed until an acceptable level of accuracy is reached, e.g., an F1 score of ^{˜}98, wherein F1 Score=2*Precision*Recall/(Precision+Recall).

Thereby, detect the similarity of the chat and the similar chats. Use the same weights for both the LSTMs. Use this LSTM (referred to as Pre-trained Similarity LSTM), to find the similarity score between the audio to text converted information and the chat written by the user on the platform in the production.

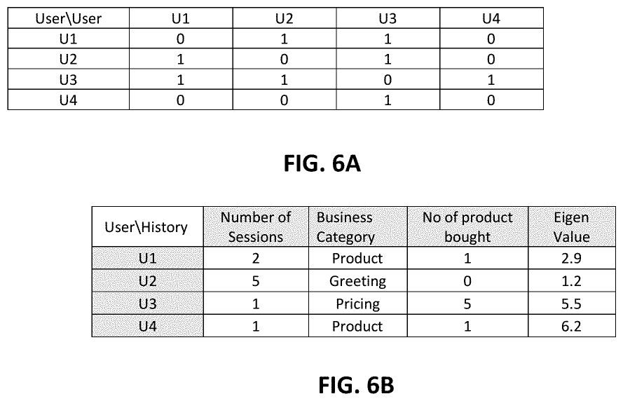

FIG. 6A illustrates an example adjacency matrix, describing user-user connectivity from social media. If two users are connected then it is 1, else it is 0. FIG. 6B illustrates example Eigen values calculated based on the user's historical information.

The training method for Classification LSTM is described as follows. The pre-processing steps and the conversion of the text remains the same as mentioned in the above, i.e., removing the punctuation, removing the stop-words, expanding the contractions, passing the text of the chat column and the similar chat into a texts to_sequences function, and padding the sequence if a number of tokens is less than a predetermined number, e.g., a number of tokens are less than 25.

The two streams of data are passed into a 50 dimensional Embedding to feed into a 30 neuron LSTM. The weights are shared by both the LSTMs. The performer' output vector (y2) gets multiplied by the output of the pre-trained similarity LSTM sigmoid score to get the modified performer output vector (y3). This ensures that if the content being discussed has no correlation with the chat or the audio to text output is noisy, it doesn't impact the importance of the real chat being typed by the user. This also ensures that both the data inputs are taken into account when the chat and the audio to text is similar, and thereby it justifies the presence of the similarity LSTM.

The LSTM outputs (user vector and the modified performer vector) get concatenated with the user history vector, described in detail below. The user history vector comprises of the information about the user in terms of the number of sessions he or she has attended, the number of products bought, the mode of the business category chosen, if he or she is logging in for the first time, the corresponding values would be 0 and ‘unknown’. The user's social connectivity (importance) is measured by the Eigen centrality of the user graph that is generated from the adjacency matrix of the users on an online Social media platform. This matrix is stored in a database and can be queried in the production environment as and when required.

The user vector gets concatenated with the LSTM outputs generated and then passed into a dense layer of 20 neurons, another dense layer of 10 neurons and thereafter another dense layer of 5 Neurons with an activation function of Softmax.

The customized loss function 406 at the output layers is customised as given below:

$${{\sum }^{Training Examples}}_{k = 0} λ j * {{\sum }^{Classes}}_{i = 0} - {y}_{a c t u a {l}_{i k}} * log ( {y}_{{pred}_{ik}} )$$

where y_actualᵢₖ is the variable which will be 1 when the class i is the output of the chat and y_predᵢₖ is the probability (softmax output) returned by the model for the corresponding class, sum it up for across all the classes, weigh it with λj and sum it up across all the training samples. λj is the harmonic mean of the Eigen centrality of the user u obtained by decomposing the user-user interaction matrix and the standardised value of number of sessions the user has attended, number of products purchased by the user.

The model is trained with 1000 samples. The F1 score of the model on validation_data (500 samples) stands at a desired F1 Score.

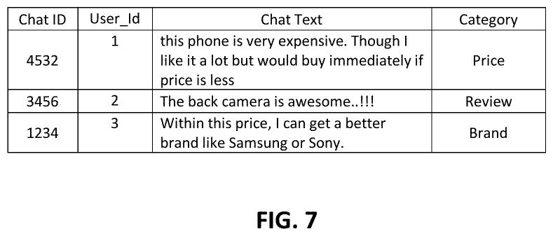

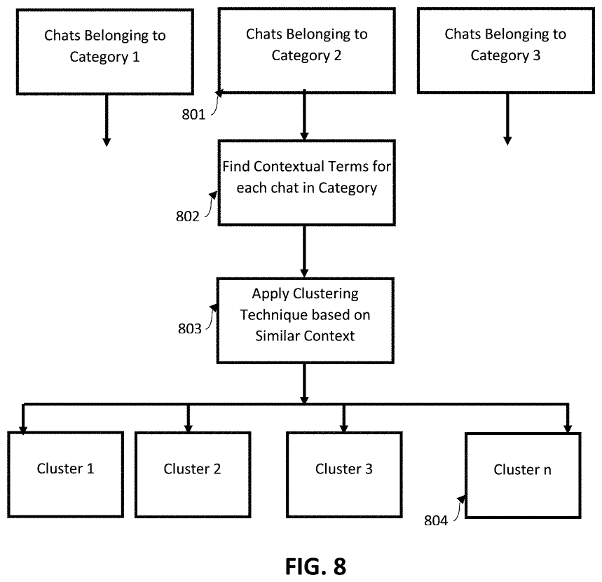

Described herein is an example method of clustering of chats. FIG. 7 exemplarily illustrates the categories of chats. FIG. 8 illustrates an example method of clustering of chats. The event organizer may wish to take suitable action based on each review/chat. Certainly, the event organizer cannot handle each chat one by one, and hence may prefer an arrangement where all the chats talking about similar topics (context) are grouped together by context. The SCC platform may group the chats in a business category based on similarity of their context. This context is derived from the chat using grammar rules. After finding context terms for each chat, apply clustering techniques.

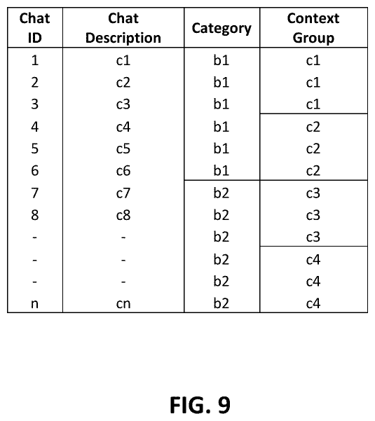

FIG. 9 illustrates the results of clustering.

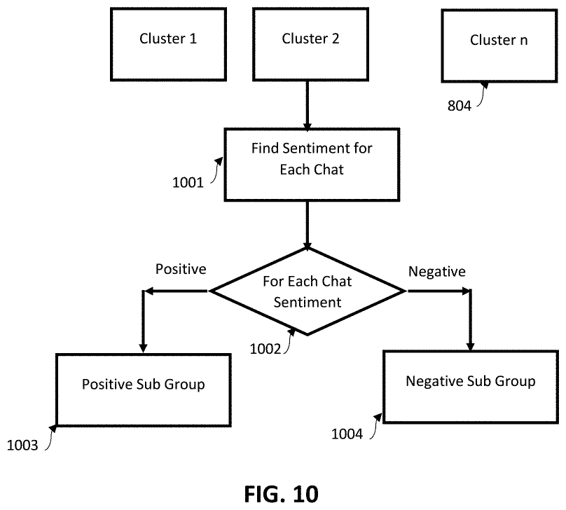

Moreover, the event organizer may want to give a greater preference to a chat with positive or negative sentiments. FIG. 10 exemplarily illustrates the results of segmentation of chats into positive and negative sentiments. This sentiment is derived 1001 for each chat. FIG. 10 illustrates the method of segmentation of chats into positive and negative sentiments 1002. The SCC platform may divide each group in two sub groups positive and negative based on sentiment score. If sentiment score <0, then the chat is sent to a negative sub-group 1004, and if the score >=0 then the chat is sent to a positive sub-group 1003.

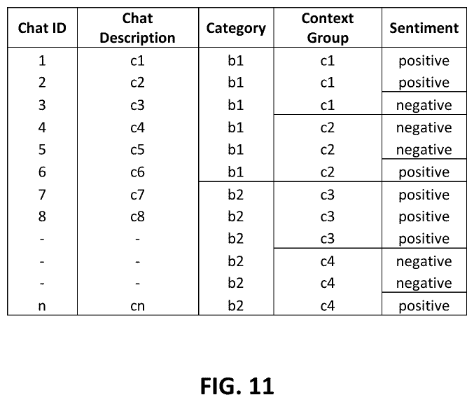

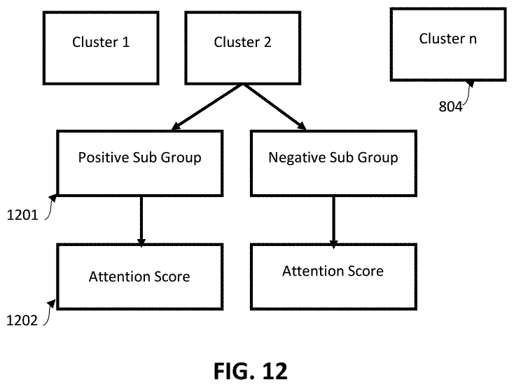

FIG. 11 illustrates an example method of computing attention scores. FIG. 12 illustrates the results of the computed attention scores 1202 from the positive and negative subgroups 1201.

Moreover, the event organizer may want to answer/handle chats belonging to one group earlier than other groups. For example, consider the case wherein 100 people are asking “Is your yoga technique is safe for pregnant women” and 20 people are asking for “can a person with high BP also do this yoga”. In this case, the organizer would like to answer question asked by 100 people before he answers the group of 20 people. This precedence depends not only upon count of chats in one group but also on how “important” are the sentiments of chats in one group over other. For example, the event organizer may want to handle chats furious about “failed payment” than talking negatively about “camera quality” or other questions. Thus, the system takes into account the sentiments of the chats along with the number of chats and computes a score called “attention score” for each sub-group. This attention score shows the relative importance of one group comparted to other groups.

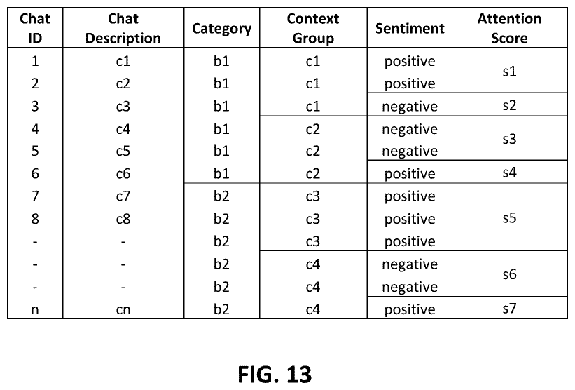

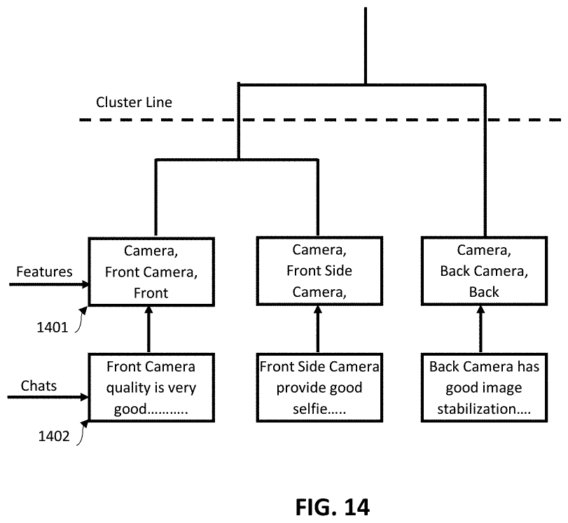

FIG. 13 illustrates a detailed table wherein the event organizer can see the entire chat review as per his or her desired filtering. For example, the event organizer can view all chats in the business category “brand” and talking “negatively” about “camera” and arrange them in decreasing order of “attention score”.

Described herein is the method of context terms extraction. The event organizer would like to group the chats/review which are based on a similar topic or object. For example, “The camera is excellent”, “placement of camera is not good”, “Camera giving blurred pictures in low light” etc. are discussing the camera. Though sentences are containing many words, the main object of interest from these sentences is to be extracted. There may be more than one object of topic in a chat, for example “Though price is high, but having such a great camera, sensors, scratch proof gorilla glass and 6000 mAh battery makes it a good deal”. In such cases, extract multiple objects of interests (contexts).

Described herein is the method of identifying object or contextual words. A sentence consists of many words (tokens) and punctuations symbols. From the grammar of the language, identify the word acting as noun, pronoun, adjective, preposition, article, verb etc. The method of identification of words acting as verb, noun, adjective etc is well known in the art. These methods incorporate the POS (part of speech) tagger. POS (Part of Speech) are the tags assigned to each word (token) in the sentence displaying whether a given word (token) is acting as a noun, verb, adjective etc. i.e., a linguistic tag. Exemplarily, Brills' method may be applied to find (locate) the POS tag for each token of a sentence. The following are examples of predominantly used Part of Speech tags: NP (Noun Phrase), VP (Verb Phrase), PP (Prepositional Phrase), DT (Determiner), V (Verb), NN (Noun), IN (Preposition), AD (Adjective).

Define the context as “noun” or “object” around which a sentence is structured. Nouns can be found in different forms in an English Sentence e.g., plain noun, with adjective, with preposition, with adverb etc. For example, “Front Camera”, “Camera on the back panel”, “Very Nice Camera”, “The Camera” etc. Head or object noun from the prepositional phrases is extracted using the usual meaning of preposition/adjective. For example: “Camera on the back panel” is about the “camera” and not about the “back panel”, hence the object noun is “camera”. The complete noun phrase is represented in another form which becomes “back panel camera”, where “back panel” is modifier. Thus, extract head nouns and the modifier from prepositional/adjective phrases.

Simple noun phrases and adjective noun phrases consists of two parts modifier and head nouns e.g., “Protective Glass”, “Ambient light sensor” etc. have head noun “glass” and “sensor” respectively and “protective” and “ambient light” are the modifiers.

The above extracted noun phrase, head nouns and modifiers serve as contextual terms used for cluster formation.

Described herein is an example method of determining an attention score. Calculate the sentiment score of the chat using general machine learning. The score is in the range between −1 (negative) to +1 (positive).

RepL (Repeated Letter Count): Find all words with repeated letters such as “tooooo”, “coooool” and find characters significantly repeated a maximum number of times. This count is saved as RepL. For example, for the sentence “This glass finish is tooooo . . . good”, the RepL is 4 because correct word “too” has 4 more “o”.

RepW (Repeated Word Count): Find all consecutively repeated words which acts as adjective modifier and their count is RepW. If more than words are repeated then we sum that count. For example, for the sentence “The price of this is very very very high as compared to other similar product” the RepW is 2.

RepE (Emoji count): Count all emojis used in the sentence and called as “RepE” for example: “I love the quality of screen and edges [symbol] and price is really too cheap [symbol] ” has RepE value 3.

Emotional Weight EW is computed as follows:

EW=Sqrt[(RepE)\hat{ }2+(RepW)\hat{ }2+(RepL)\hat{ }2]

Attention weight for a chat AW is computed using:

AW=EW*|S|

wherein, EW is Emotional Weight and |S| is magnitude of sentimental score of chat.

The above determined score is unbounded and used only to show relative importance of one group over other. If required, it can be normalized to a predefined range.

Attention Score for a group of chats is described herein. For a group of chats having n chats/reviews, we compute the attention weight of each chat and compute the group's attention score as follows:

$$AS = {\sum }_{i = 1}^{i = n} {AW}_{i}$$

The above score is unbounded. It does not need to be in some range as only the relative attention score of each cluster (group) is considered important.

The method of computing the sentiment is described herein. Each chat has a sentiment that is positive, neutral, or negative. A chat may be less negative than the other, similarly one chat may be more positive than the other chat. Hence, calculate a score of measuring the sentiment of a chat from −1 (high negative) to +1 (high positive). Neutral chats will have a score of zero. There are many, well-known, machine learning methods to determine the sentiment category and score for texts. Any of these machine learning methods may be applied to compute the sentiment score.

The clustering technique is described herein. In the method described herein, chats are not clustered directly. Instead, extract context terms and use them to perform the clustering. Apply a different weighing technique for contextual terms.

The method of special feature extraction and weighing is described as follows. All contextual terms extracted. Identify all noun phrase contextual terms.

If noun phrase has no modifier, then assign noun phrase a weight of 1.0.

If noun phrase has modifier also, for the complete noun phrase assign weight 1.0. Extract object/head noun from noun phrase, and for an object noun give some less weight (0.75). For other tokens from noun phrase give further less weight (0.25). Example: from noun phrase “front camera” we get two features “camera” and “front camera”. For “camera” we assign less weight (0.75) and for noun phrase “front camera” we assign weight 1.0.

The above weighing method is a type of relative scaling of features. It gives importance to completely matching with nouns and modifiers, and gives a lesser importance to only nouns.

The method of clustering chats is described herein. Use a standard clustering algorithm to find the clusters of chats. As it is not possible to know in advance the number of clusters, use an agglomerative clustering technique as described below.

Find the features from each chat and give appropriate weights as described above. Treat each chat as individual cluster. Find inter cluster distance (dissimilarity) for all clusters. Here use appropriate distance with use of different weights for different features. Find the two clusters having a minimum distance and group them together. Update the inter-cluster distance and repeat the process by going back a step until a single cluster or desired number of clusters is derived. The desired number of clusters is a hyper-parameter and decided manually during real life experiments.

FIG. 13 illustrates a dendrogram on the clustering of chats.

The processing steps described above may be implemented as modules. As used herein, the term “module” might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. After reading this description, it will become apparent to a person skilled in the relevant art how to implement the invention using other computing modules or architectures.

In general, the modules/routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), flash drives among others.

Modules might be implemented using a general-purpose or special-purpose processing engine such as, for example, a microprocessor, controller, or other control logic. In the illustrated example, the modules could be connected to a bus, although any communication medium can be used to facilitate interaction with other components of computing modules or to communicate externally.

The computing server might also include one or more memory modules, simply referred to herein as main memory. For example, preferably random access memory (RAM) or other dynamic memory, might be used for storing information and instructions to be executed by processor. Main memory might also be used for storing temporary variables or other intermediate information during execution of instructions to be executed by a processor. Computing module might likewise include a read only memory (“ROM”) or other static storage device coupled to bus for storing static information and instructions for processor.

The database module might include, for example, a media drive and a storage unit interface. The media drive might include a drive or other mechanism to support fixed or removable storage media. For example, a hard disk drive, a floppy disk drive, a magnetic tape drive, an optical disk drive, a CD, DVD or Blu-ray drive (R or RW), or other removable or fixed media drive might be provided. Accordingly, storage media might include, for example, a hard disk, a floppy disk, magnetic tape, cartridge, optical disk, a CD, DVD or Blu-ray, or other fixed or removable medium that is read by, written to or accessed by media drive. As these examples illustrate, the storage media can include a computer usable storage medium having stored therein computer software or data.

In alternative embodiments, the database modules might include other similar instrumentalities for allowing computer programs or other instructions or data to be loaded into the computing module. Such instrumentalities might include, for example, a fixed or removable storage unit and an interface. Examples of such storage units and interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module.

The communications module might include various communications interfaces such as an Ethernet, network interface card, WiMedia, IEEE 802. XX or other interface), or other communications interface. Data transferred via communications interface might typically be carried on signals, which can be electronic, electromagnetic (which includes optical) or other signals capable of being exchanged by a given communications interface. These signals might be provided to communications interface via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer implemented method of chat categorization of user(s) on an online platform, wherein said user(s) communicate with one or more performers in a chat session, comprising:
passing chat text of said user(s) and chat text of said one or more performers into a first pretrained similarity LSTM model to generate an output score which measures the similarity of the chat text of said user(s) and the chat text of the one or more performers, wherein said output score is a sigmoid score;
passing the chat text of said user(s) and the chat text of the one or more performers through a second pretrained classification LSTM model in parallel, and generating two corresponding two output vectors;
multiplying said sigmoid score with said output vectors to create a consolidated vector;
passing said consolidated vector into a dense layer of a neural network and classifying chats in said chat session into a set of categories; and
determining a customised loss function.

2. The method of claim 1, wherein, said first pretrained similarity LSTM model encodes information of the user(s), and second pretrained classification LSTM model encodes information of a matching performer's content.

3. The method of claim 1, further comprising, prior to passing the chat texts through a corresponding LSTM module, tokenizing the chat texts and generating a sequence on the chat texts to convert the chat texts into numeric representations.

4. The method of claim 1, further comprising determining a social connectivity of the user(s) based on an Eigen centrality of a user graph that is generated from an adjacency matrix of the user(s) on an online social media platform.

5. The method of claim 1, wherein said customized loss function is a harmonic mean of an Eigen centrality of the user obtained by an adjacency matrix and a standardised value of a number of sessions attended by the user or a number of products purchased by the user.

6. The method of claim 1, wherein said customized loss function uses past behaviour and social connectivity of the said user(s) for a prediction of a chat category by modifying the loss function.

7. The method of claim 1, further comprising concatenating the user and the performer output with a user history vector.

8. The method of claim 7, wherein said user history vector is generated using a user data base of historical purchases and a user-user adjacency matrix.

9. The method of claim 7, wherein said user history vector comprises information about the user in terms of a number of sessions attended by the user, a number of products purchased by the user, and a mode of business category selected by the user.

10. The method of claim 1, wherein if said chat is in an audio format, said audio format is converted to text using a speech recognition module.

11. A computer implemented method of context based clustering of chat sessions of a set of users on an online platform, wherein said users communicate with one or more performers in said chat session, comprising:
clustering said chat sessions and grouping the chat sessions based on similarity of context of each chat session;
extracting context from each chat session;
grouping of the chat sessions into categories based on the respective context of each chat session;
computing an emotional weight for each chat session; and
determining an attention score for each group of chat sessions in a category.

12. The method of claim 11, wherein each said clustered chat session is divided into two sub groups based on positive and negative sentiment of the chat sessions.

13. The method of claim 11, wherein said clustering comprises:
determining features from each chat and assigning suitable weights, wherein each chat is treated as an individual cluster;
determining an inter-cluster distance for all clusters, wherein a suitable distance is applied with use of different weights for different features;
identifying two clusters having a minimum distance and grouping them together; and
updating the inter-cluster distance and iterating until a single cluster or a desired number of clusters is determined.

14. The method of claim 11, wherein for each subgroup of chat sessions, an attention score is computed using textual content representing emotion such as emojis and a number of chats.

15. The method of claim 11, wherein a final report is presented to an event organizer to take a desired business action.

16. The method of claim 11, wherein the said step of determining the attention score comprises the step of:
computing the Emotional Weight (EW)
EW=Sqrt[(RepE)\hat{ }2+(RepW)\hat{ }2+(RepL)\hat{ }2];
computing an attention weight (AW) for a chat
AW=EW*|S|,
wherein EW is Emotional Weight and |S| is magnitude of sentimental score of chat, RepL is a Repeated Letter Count; RepW is a Repeated Word Count and RepE is an Emoji Count; and
computing an attention score for a group of chats, wherein for a group of chats having n chats per review, wherein an attention weight of each chat and the attention score is computed using:
$$AS = {\sum }_{i = 1}^{i = n} {AW}_{i} .$$

17. An online chat categorization and clustering system applied to a set of users and performers communicating on an online platform in chat sessions, comprising;
at least one processor;
a non-transitory computer readable storage medium communicatively coupled to said at least one processor, said non-transitory computer readable storage medium configured to store modules of said online chat categorization and clustering system, said at least one processor configured to execute said modules of said online chat categorization and clustering system; and
said modules of said online chat categorization and clustering system comprising:
a categorization module for chats further comprising:
a first LSTM module for receiving a user's text and a performer's text, and applying a first pretrained similarity LSTM model to generate an output score that measures a similarity of said user's text and said performer's text, wherein said output score is a sigmoid score;
a second pretrained LSTM module for receiving said user's text and the performer's text through the two pretrained Classification LSTMs in parallel, and generating corresponding two output vectors;
a computation module for:
multiplying said sigmoid score with said output vectors to create a consolidated vector; and
passing said consolidated vector into a dense layer of a neural network and to classify the chats into a set of categories; and
determining a customised loss function;
a clustering module for:
extracting context from each chat;
grouping of said chats into categories based on context;
computing emotional weight for each chat; and
determining an attention score for each group of chats in a category; and
a reporting module for presenting said categorized, clustered, and attention scores of the chat communication.

18. The system of claim 17, wherein said system is a cloud based system with a collection of servers.
